(19) United States
(12) Patent Application Publication
(10) Pub. No.: US 2025/0001274 A1
(43) Pub. Date: Jan. 2, 2025

(54) METRONOMICALLY OSCILLATING BATTING TEE

(71) Applicant: Phillip Scott, San Diego, CA (US)

(72) Inventor: Phillip Scott, San Diego, CA (US)

(21) Appl. No.: 18/757,231

(22) Filed: Jun. 27, 2024

Related U.S. Application Data
(60) Provisional application No. 63/523,587, filed on Jun. 27, 2023.

(51) Int. Cl. A63B 69/00; A63B 71/02; A63B 71/06; A63B 102/18; G04F 5/02

(52) U.S. Cl. CPC A63B 69/0075; A63B 69/0002; A63B 71/023; G04F 5/022; A63B 2069/0008; A63B 2071/026; A63B 71/0619; A63B 2102/18; A63B 2102/182; A63B 2225/093

(57) ABSTRACT

A ball-striking training device for batting tee practice based on the functionality of the metronome. The metronomically oscillating batting tee includes a base, a moveable stem, a receptacle, a driver, a timing mechanism being locally or remotely controlled for oscillating the ball back and forth atop the tee for a predetermined timing interval.

### CROSS-REFERENCE TO RELATED APPLICATION

This application claims priority to U.S. Provisional Application No. 63/523,587, filed on Jun. 27, 2023, the disclosure of which, including any materials incorporated by reference therein, are incorporated herein by reference in their entireties.

### FIELD OF THE INVENTION

In the late 1500s, Galileo discovered the isochronism of the pendulum. In the next century, Christiaan Huyghens and George Graham invented the pendulum powered clock. In the late 1600s Étienne Louilié designed a metronome with an adjustable pendulum. In the early 1800s, a German inventor devised a ‘musical chronometer’ capable of adjusting the tempo to play fast and slow. He did not patent his device. The metronome, as we know it, was patented in 1815, and adopted in 1817 by Beethoven. In the 1990s, metronomes were used in medical fields for rehabilitation of those with learning and movement disabilities.

The metronome has been especially useful for over two hundred years for musicians by helping them practice keeping an extremely accurate tempo.

The functionality of the spatiotemporal part of the brain, the timing network, is not only connected with motor performance, but more importantly to executive functions. There is a growing body of evidence confirming that ‘timing training’ is beneficial in a variety of rehabilitation and clinical settings. This includes, but is not limited to, motor planning, sequencing, and cognitive functions like attention and memory. This concept of timing training has also gained traction in sport and fitness settings to enhance athletic performance. In sports and recreational activities, it is understood that hitting a moving object with a bat, racket, or club fundamentally requires the user to be in the right place at the right time. For example, during the period of time in which a ball is pitched from a cricket bowler or baseball pitcher or served from a tennis player, the amount of time available to make a decision and make a play for the desired shot or swing is minimal and always changing. Factors like the spin of the ball and the wind can affect the speed and movement of a ball, meaning the ball striker must adjust their swing to either maintain, quicken, or slow their tempo to optimally execute the task. To be successful, synchronization includes movements that require timing and the coordination between the user's internal timing mechanisms and motor production.

Synchronized sensorimotor timing skills are important for all daily actions. There is a growing body of evidence confirming the positive effects of Synchronized Metronome Training (SMT) for improvements of timing and performance.

Unlike current SMT use cases, the present invention allows physical interaction between a body part or an extension of a body part, such as, but not limited to, a bat, club, or racket. A body part or piece of equipment that makes contact with a metronomic value receives aural and optical feedback, like current SMT use cases, but also receives distinctly physical feedback by connecting a metronomic value to the contact point. The athlete must adjust their speed and synchronize movements to execute the task.

In recent years, athletes have used metronomes to improve their timing by means of aural and optical feedback. The earliest chronometers provided only optical feedback. They were soundless and required the user to keep them within view. The first “musical” metronomes provided aural feedback. One purpose of the present invention is to provide physical touch feedback by means of making contact with the metronomic device. This creates an even stronger connection between sensory-perception and motor production. Our invention allows a user to interact with the metronome through a body part or piece of equipment.

The limitation of the traditional metronome that transmits aural and optical feedback is the lack of tactile feedback. If the piano player's fingers made contact with the metronome, such feedback would be present. But without such contact, the transmission of metronomic value is limited to aural and optical.

The present invention differs from all others in that it provides the ability to physically strike the ball fixed atop the tee, which is effectively the endpoint of the metronome arm, which is set to a specific, measurable tempo. This physical interaction with metronomes is unique, functionally different, and has never been demonstrated.

In sports, hitting a moving object is an extremely difficult task. Throwers or tennis servers are regularly throwing different speeds, thereby setting the required tempo, forcing ball-strikers to maintain or adjust the timing mechanisms and movements of their swing. Currently, there are batting tees, ball launching machines, and many other devices designed to improve performance for ball strikers.

Traditional batting tees are most often set to a certain height in a fixed, nonmoving position for the batter. Some batting tees allow the ball to move. In these instances, the ball can swing back and forth from a string, like a rope hanging from a tree. Some present the ball from a different angle or with a certain technology, such as vacuum or suction cup or by means of a receptacle, as referenced in U.S. Patent Publication Number 2013/0109508 entitled “Hitting device with resilient strap” and U.S. Pat. No. 10,315,091 entitled “Wearable batting tee system and use thereof,” both of which are hereby incorporated by reference as if fully recited herein.

Traditional batting tee systems comprise a base and a stem (elongated member or shaft) with the base configured to hold the stem upright. The shaft is generally affixed to the base at one end, with a ball-receiving receptacle configured at the other end. A batter can use a traditional batting tee system by resting a ball on the ball-receiving receptacle and swinging a bat, club, or other object at the ball. The tee system is one preferred method of teaching players on the appropriate swing mechanics, but still allows for good effects (e.g. hitting the ball far) with less than ideal form or timing. In addition, the ball is stationary, providing limited simulation of real game situations.

Conventional hitting aids may move a ball mechanically or robotically, such as those disclosed in U.S. Pat. No. 8,425,352 to Loduca et al.; U.S. Pat. No. 10,112,097 to Loduca, et al.; U.S. Pat. No. 10,639,533 to Loduca et al.; U.S. Pat. No. 6,146,289 to Miller et al., all of which are of which are hereby incorporated by reference as if fully recited herein.

However, traditional or mechanical ball-striking training aids may be insufficient for enabling a ball-striker to develop the appropriate timing, tempo, or rhythmic skills required to accurately perform the task of hitting a moving ball. In addition, the delivery path of the ball is often not realistic compared to actual game play (e.g. directly horizontally or vertically or both). In live pitching scenarios, the ball moves on an arc because of the effect of gravity, which pulls it slightly towards the ground. Factors such as spin rate, release point height, and velocity can all affect the trajectory and arc of a moving ball.

Other conventional devices for developing ball-striking skills against a moving ball include pitching machines, in which the ball is propelled, shot, or launched from a certain distance to an uncertain location. The first pitching machines were effectively cannons and guns and they were very dangerous and very unpredictable. The latest pitching machines are more accurate and predictable, but they still lack an exact measurability that translates to the desired task of timing a moving ball with a bat. The latest mechanical batting tees may be accurate with respect to movement, but they lack a distinct measure of accuracy with respect to timing.

Different kinds of devices have been available for aiding persons of various ages in the development of ball-striking skills. For example, a variety of different types of batting tees have been available for positioning balls in the space where batters can swing the bat and make contact with the ball. Devices like this have been found to be effective for assisting in the development of ball-striking skills. They have been found to be especially effective for use in the introductory leagues of the game of baseball or softball called “Tee-Ball”.

Ball-tossing devices or pitching machines, which launch balls into the air have generally been found to be effective in the development of slightly more advanced ball-striking skills. Various kinds of devices which are capable of tossing or pitching balls have been found to be effective for aiding both children and adults in the development of advanced ball-striking skills. However, the available devices have generally not been adapted for use by children initially learning the requirements of the game. For example, the focus of “Tee Ball” is to create an environment where children learn how to swing the bat at the ball, which is not moving, resting atop the batting tee. The next step for children after Tee Ball is the transition to moving pitch coming from either a machine or a person. There have been no “pitching tees” invented to date that combine the best features of both batting tees and pitching machines.

The present invention relates to ball-striking sports in which timing is a fundamental problem facing the athlete, particularly the moving pitch and more particularly to a ball-timing device for aiding young children or trained adults in the development of batting skills.

### SUMMARY OF THE INVENTION

A metronomically oscillating training device/batting tee for learning polyrhythmic ball-striking skills. The training device, batting tee has a base, stem (arm), a ball holder connected at one end of the stem (arm) and a mechanism for metronomically oscillating the stem (arm) connected to the other end of the stem (arm).

A metronomically oscillating training device/batting tee for learning polyrhythmic ball-striking skills. The training device, batting tee, has a base, stem (arm), a ball receptacle connected at one end of the stem with a ball affixed atop the other end of the stem (arm), and a drive mechanism for metronomically oscillating the stem (arm) connected to the other end of the stem (arm).

In particular, provided herein are metronomic batting tee systems that allow users to develop measured and consistent swing decisions, movements, and timing while hitting a ball. In some instances, improper and/or extraneous synchronization of motions and timing by a batter can cause the bat to not be delivered properly to the point of optimal contact. Further, in some instances, even with measured and proper swinging, the ball is moving, forcing the batter to track the ball path. Such systems and processes more closely mimic real life hitting situations than do traditional tee systems. Such systems also allow for a more controlled and predictable environment for learning swing timing, tempo, and rhythm.

The present invention is one that may display an exact and extremely accurate representation of movement and timing, tempo, and rhythm by means of a metronomic value, which is being necessarily driven by any suitable simple mechanism. The name of the invention itself is based on the Greek words metron, meaning “measure,” and nomos, meaning “law.”

Metronomic functionality is relevant for timing, particularly in music, dance, and recently for sports, specifically baseball where the batter aims to swing the bat the right way at the right time against a moving ball. This is especially significant considering common language and practices of the sport in general, which generally operates in miles per hour readings or revolutions per minute.

In some embodiments, provided herein is a metronomically oscillating batting tee, wherein a stem is attached to a base and a mechanism, which is being driven or otherwise moved. At a distal end of the stem is a ball receptacle with ball being held in the ball receptacle, the stem and ball receptacle moving together and oscillating in a single plane.

In certain embodiments, provided herein is a metronomically oscillating batting tee system having a base: a stem: a ball receptacle connected to a distal end of the stem; a metronomic mechanism or drive connected to the end opposite the distal end of the stem, wherein the metronomic mechanism or drive oscillates the stem metronomically.

In some embodiments, the stem thereof has an adjustable length and/or has a telescopic body. In certain embodiments, each component of a system herein is independently selected from any suitable material, such as by way of non-limiting example, natural materials (e.g., wood), synthetic fabric, plastic, composite, metal, or a combination thereof. In some embodiments, the elongated body comprises wood, plastic, composite, metal, rubber, or a combination thereof.

Any suitable ball receptacle is optionally included, such that it is durable, as to withstand forces of impact, and capable of securing any ball at or near the distal end of the tee (i.e., distal to the base). In specific embodiments, the ball receptacle comprises a suction cup, a flexible or elastic band (e.g., large rubber band), or a strap comprising fabric and/or plastic hook and loop fasteners (e.g., Velcro®). In some embodiments, the ball receptacle is configured to harness any ball atop the tee. A user may interchange ball receptacles with respect to ball size, shape, and oscillation frequency. In certain embodiments, the tee is positioned to move parallel to a user's stance, similarly to the same plane as a pitched ball from a machine or person. In some embodiments, the tee is positioned directly in front of the user and turned sideways, and the ball moves directly away from and back towards the user.

### BRIEF DESCRIPTION OF DRAWINGS

FIG. 1 is a perspective view of the metronically oscillating batting tee in accordance with an embodiment of the present invention; and

FIG. 2 is a schematic representation of the mechanical and electrical components of the metronically oscillating batting tee in accordance with an embodiment of the present invention.

The foregoing features and other aspects of the invention are explained in the following description taken in conjunction with the accompanying figures. Further understanding of the features and advantages of the invention will be obtained by reference to the following detailed description that sets forth illustrative embodiments, in which the principles of the invention are utilized.

### DETAILED DESCRIPTION

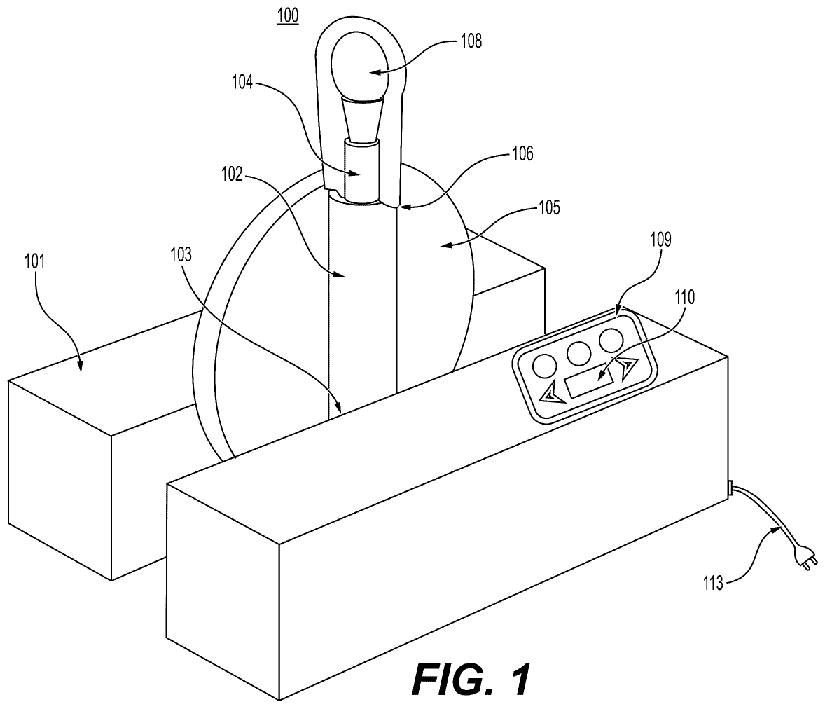

A metronomic batting tee system 100 having base 101, a stem or arm 102 connected to the base 101 and a ball holder 104 holding a ball 108 at a distal end thereof (ball receptacle). The stem/arm 102 oscillates at given intervals to challenge a batter to hit a moving target at given intervals mimicking live play. An exemplary metronomically oscillating batting tees can be seen in FIG. 1.

The ball receptacle (or holder) 104 can be made from a resilient material (rubber, plastic, natural, etc.) with adjustable sizes to fit softballs, tennis balls and made for rackets or bats to be able to move at high speeds and stay securely fixed atop the tee. The ball receptacle 104 holds the ball securely atop the tee as it moves back and forth at different speeds, direction changes, and angles.

The ball receptacle 104 is designed to sheath the ball enough to prevent it from being pulled off the receptacle by high-force movement, but enough to still exit the receptacle well.

At the other end of the ball receptacle 104 is a metronomic mechanism 105, which can include a time-indicating device.

In some embodiments, the metronomic drive is set as low as, but is not limited to, 40 beats per minute. In some instances, the tempo can be set to as high as, but is not limited to, 180 beats per minute.

In some embodiments the tempo can be set to increase or decrease gradually or rapidly. This requires the user to speed up or slow down their movement in order to accurately make contact with the endpoint of the metronome or the object at the end of the metronome.

In some embodiments, the aural feedback can be any sound or beat. In some embodiments songs or cues or affirmations can be played over the set time scale or set to play continuously.

One novel feature, among others, of the present invention is the functional accuracy of the metronome. It is a measurement, the degree to which the result of a measurement, calculation, or specification conforms to the correct value or a standard. The functionality and structure of the training device are precisely tuned to fit the demands of the metronome's functionality. Precision is the refinement in a measurement, calculation, or specification, especially as represented by the number of digits given.

A certain length, time, and variability over which it can operate can be set for the device, which can be useful for learning the fundamentals of timing by setting the tempo for the hitter to maintain the necessary speed to complete the task. Changing these setting can be particularly useful for beginners who are just learning the basics of the sport. For example, in baseball and softball, many players first play in a Tee Ball league, where a traditional batting tee is set atop home plate for the batters to hit. Many players graduate from Tee Ball and move into a machine pitch league or coach pitch league.

The transition from Tee Ball to machine or coach pitch league can be difficult for many players because of the drastic change going from a non-moving ball on a tee to a fast-moving ball that may or may not be accurately thrown in the direction of the batter. The training device in accordance with the present invention is an improvement on both a pitching machine and a tee. The device can deliver the ball safely, accurately, but in a manner that will help them learn the most fundamental skill in sports-timing. By learning timing mechanisms at a younger and more formative age, athletes will develop a better skill set to play the game better and enjoy the experience more.

One purpose of this invention is to cause an effect of synchronized metronome training (SMT) on sensorimotor timing ability in ball striking.

In practice, the arm of the batting tee oscillates forward and backwards (and side-to-side, if desired) metronomically to challenge a batters timing and skill in hitting a ball. A dial can be used (as in a traditional pitching machine) to increase and decrease the frequency of the movement. The length of the arm can be adjusted to accommodate batters of differing size and height.

Various drives and mechanisms can be used to move the arm of the batting tee device metronomically including, but not limited to, escapement mechanisms, quick return mechanisms, gear mechanisms, linkage mechanisms, or any other mechanisms, motors, or drives that generates an oscillating or reciprocating are. The mechanism should be capable of maintaining a steady tempo and capable of subtracting or adding a fixed proportion of the oscillation, the tempo adjustment.

Escapement mechanisms are used in traditional metronomes and clocks and are driven by force from a coiled spring or a suspended weight, transmitted through the timepiece's gear train. Each swing of the pendulum or balance wheel releases a tooth of the escapement wheel, allowing the clock's gear train to advance or “escape” by an accurate and fixed amount. The swinging motion of the pendulum pushes on a fork, which releases an escapement wheel that is attached to a counterweight. When the wheel is released, gravity pulls the counterweight down, and the wheel starts to turn.

A quick return mechanism is an apparatus that converts circular motion into reciprocating motion in presses and shaping machines, which are utilized to shape stocks of metal into flat surfaces. This mechanism is mostly used in shaping and slotting machines and in rotary internal combustion engines.

Linkage mechanism is the concrete procedure, regular event, arrangement, device, or channel which bridges the gap between components of the system and allows communication or movement between them. It is an assembly of systems connected to manage forces and movement. Car windshield wipers are an example.

Gear mechanisms are used for heavier more industrial movements. Other mechanisms include but not limited to approximate straight-line mechanisms, exact straight-line mechanisms, or any gear, pulley, linkages, or belt mechanisms capable of causing a constrained and predictable motion.

Power sources for the batting tee include, but are not limited to, a battery, an electrical cord, a manual foot pedal, like that of a bass drum foot pedal, or a spring, like that of a mechanical metronome.

Provided in general embodiments herein is a batting tee system, such as a metronomically oscillating batting tee. In certain embodiments, provided herein is a system comprising a batting tee comprising a base and stem that is capable of being driven to metronomically oscillate. In certain embodiments, the tee device comprises a stem (the tee “shaft”) and a ball receptacle configured at or near one end thereof. Generally, the ball receptacle is configured to secure a ball (e.g., tennis, cricket, baseball or softball) atop said stem at or near one end of the elongated body (e.g., distal to the base and driver).

Turning now to the figures, FIG. 1 illustrates a non-limiting exemplary embodiment of a metronomically oscillating batting tee system 100. As illustrated, the metronomic batting tee system 100 comprises a base 101. Stem 102 extends from base 101 and comprises a first end 103 and a second end 106, wherein the first end 103 is closer to the base than the second end when the stem is perpendicular to base 101, and a ball receptacle 104. Ball receptacle 104 is affixed to the stem 102 at or near the second end 106 (i.e., towards the end distal to the base). The ball receptacle 104 is configured to secure a ball 108 (which may or may not be a part of a system herein) distal to the stem 102 of the base 101. A driving mechanism 105 is connected to the first end 103 of stem 102 to oscillate the stem or arm 102 metronomically.

In the systems provided herein, the base, stem, metronomic mechanisms or drives, and the like comprise any suitable material, such as natural, synthetic, metal, composite, or the like materials.

Base 101 provided herein can be any suitable size, configuration, or material. In certain embodiments, the base is secured on the ground by the natural weight of the base itself, stem, and mechanism. In certain embodiments, the base can be weighted down properly by any suitable external weights. In an exemplary embodiment, the size of the base and adjustable height of the stem fits the dimensions of the strike zone, which is 17 inches across home plate (from closer to the batter to farther away from the batter) and 17 inches from the front plane on the plate (closest towards the pitcher) to the back point (closest to the catcher) of the plate. In specific embodiments, the tee is sized and configured to be stable enough to support the oscillation of the stem so that no shaking or disruptions occur during use.

Stem can be extendable, for example, in a telescoping manner. In a telescoping embodiment, the extendible tee may have one or more of an inner, outer and middle tube or poles. The tubes or poles may have various fasteners which allow the tubes and poles to be fixed at various lengths. In an exemplary embodiment the extendible tee device can extend between the lengths of 30 inches and 55 inches.

A stem provided herein comprises any suitable material. In certain embodiments, the stem or tee or elongated body comprises wood, plastic, composite, metal, rubber, or a combination thereof. In some certain embodiments, the tee device is durable, such as when the bat hits the stem 102 unintentionally, the entire tee and the working parts of the present invention are not damaged. In certain embodiments, the stem is adjustable, such as adjustable in length and/angle. In specific embodiments, the tee device or elongated body thereof is telescopic. In certain embodiments, the elongated body has a length of about 12 inches to about 30 inches, such as about 14 inches to about 24 inches. In some instances, any suitable length is optionally utilized, such as to accommodate usage by individuals of varying heights. In some instances, a telescopic body has a shortest length of about 12 inches and a longest length of about 30 inches.

In various instances, the ball receptacle is any suitable device. For example, in some embodiments, the ball receptacle comprises a suction cup, a flexible or elastic band (e.g., large rubber band), or a strap comprising fabric and/or plastic hook and loop fasteners (e.g., Velcro®). In alternative embodiments, the ball receptacle is held by a vacuum or a magnet, or a metal capable of being magnetized (e.g., wherein used in combination with a ball comprising a metal capable of being magnetized or a magnet, respectively). The length of the ball receptacle, such as extending beyond the stem, is any suitable length to accommodate any desired ball, such as a tennis ball, cricket ball, baseball, or softball. In some instance, depending on the type of ball receptacle, the length of the ball receptacle has a length of and/or extends beyond the elongated tee body by up to about 12 inches (e.g., about 2 inches to about 10 inches, about 4 inches to about 10 inches, about 6 inches to about 10 inches, about 2 inches to about 6 inches, or the like).

The tee 100 may include an outlet with a standard electrical plug 113 to power the metronomic mechanism 105 or drive, user interface 107, and communicator 111. The tee 100 may be powered by an outlet or any suitable batteries, or combination thereof. In some embodiments, the battery is rechargeable, capable of being removed, re-charged, or replaced.

The user interface 107 may include a local user interface 109 such as for turning on/off the device, setting the tempo, and starting the movement. In certain embodiments, a user may locally select a BPM (beats per minute) and set the mechanism to metronomically oscillate the stem 102 according to the exact beat value selected. The user interface 107 may include physical buttons that allow a user to turn on/off, start moving the tee, stop moving the tee, increase BPM by double, decrease BPM by half, or any metronomic configuration therein. When the desired tempo is selected and the tee is positioned in the desired location, the user may select the GO button to begin metronomic oscillation. In similar embodiments, the user may select STOP after the ball has been struck, at which point the user may replace the ball atop the ball receptacle for another repetition.

Local user interface 109 may include a display 110. The display 110 may include LED lights to indicate as such the operations and battery 112 life. The metronomic mechanism 105 may also connect to a communicator 111, which may include a receiver, transmitter, etc. The communicator 111 may be configured to allow communication between the user interface 107 and other devices, external or internal power sources or remote devices. In some embodiments, the communicator 111 may comprise wired connection, wireless communication, or both. In other embodiments, the communicator 111 is configured for wireless communication such as Bluetooth, IR, Wi-Fi, radio, etc. The communicator 111 may transmit data to a remote device such as a computer, tablet, smartphone/device, or remote interface.

In some embodiments, the communicator 111 may include Bluetooth communication to wirelessly pair the mechanism with an external device such as a remote controller, smartphone, speaker, etc.

In certain embodiments, a user may use the local interface 109 on the base 101 to set the maximum BPM, which in some embodiments is, but it's not limited to 230 BPM. In some embodiments, a user may use a mobile device to use the remote interface 114 to set the desired oscillation frequency (BPM). In addition, the user may increase or decrease said oscillation frequency by exact amounts (e.g. multiply BPM by two to play “double time”, or divide by two to play half time). In addition, a user may select a gradual or rapid increasing or decreasing of oscillation frequency. In other embodiments, the user can set the BPM to the exact tempo as a specific song or tune.

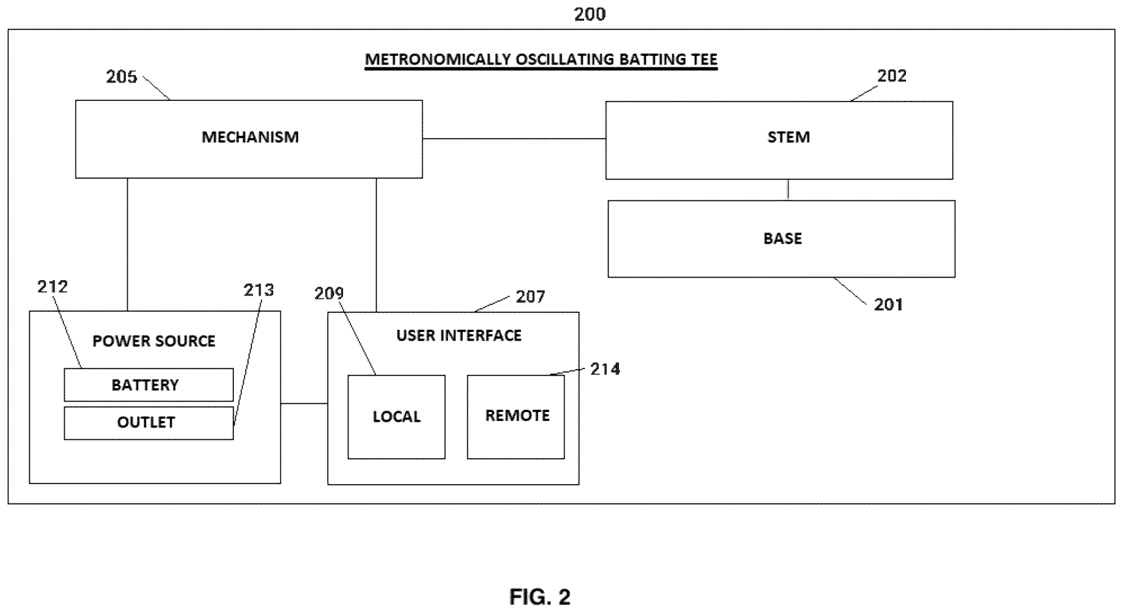

FIG. 2 depicts an exemplary schematic of the various mechanical and electrical components in the batting tee system. Metronomically oscillating batting tee 200 has a base 201 connected to a stem 202. A driver mechanism 205 is powered by a power source including a battery 212 and or power outlet 213 to oscillate stem 202. User interface 207 can include a local interface 209 located on the batting tee 200 and/or have a remote control 214.

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

As these and other variations and combinations of the features discussed above can be utilized without departing from the disclosure as defined by the claims, the foregoing description of exemplary embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible aspects.

1. A metronomically oscillating batting tee, comprising:
a base;
a stem;
a ball holder connected to a distal end of said stem;
a metronomic drive mechanism connected to the end opposite said distal end of said stem, wherein said metronomic drive mechanism oscillates said stem metronomically.

2. The metronomically oscillating batting tee of claim 1, wherein said metronomic drive mechanism is one of the following; escapement mechanisms, quick return mechanisms, gear mechanisms, linkage mechanisms, or any other mechanisms, motors, or drives that generates an oscillating or reciprocating motion.

3. The metronomically oscillating batting tee of claim 1, wherein the metronomic drive mechanism can be set to different tempos.

4. The metronomically oscillating batting tee of claim 1, wherein the metronomic drive mechanism can be set to different oscillating lengths.

5. The metronomically oscillating batting tee of claim 1, wherein the stem is adjustable.

6. The metronomically oscillating batting tee of claim 5, wherein the stem is telescopically adjustable.

7. The metronomically oscillating batting tee of claim 5, wherein the stem is angularly adjustable.

8. The metronomically oscillating batting tee of claim 5, wherein the stem is telescopically and angularly adjustable.

9. The metronomic batting tee according to claim 1, wherein said base further comprises a battery for powering said metronomically oscillating batting tee.

10. The metronomic batting tee according to claim 1, further comprising a user interface for both local and remote operation of said tee device.

11. The metronomic batting tee according to claim 1, wherein the base is weight-fillable for stabilizing the base.
